(19) United States
(12) Patent Application Publication
(10) Pub. No.: US 2022/0250731 A1
(43) Pub. Date: Aug. 11, 2022

(54) LIGHTWEIGHT AIRCRAFT WINDOW WITH LOW DRAG

(71) Applicant: SAINT-GOBAIN GLASS FRANCE, COURBEVOIE (FR)

(72) Inventors: Michel ROUBY, BRAY EN VAL (FR); Jean-Charles SAUVESTY, SULLY SUR LOIRE (FR); Sébastien SIMON, BELLEGARDE (FR)

(21) Appl. No.: 17/629,664

(22) PCT Filed: Jul. 1, 2020
(86) PCT No.: PCT/EP2020/068542

§ 371 Date: Jan. 24, 2022

(30) Foreign Application Priority Data
Jul. 26, 2019 (FR) 1908521

(51) Int. Cl. B64C 1/14; B32B 17/10; B32B 7/12

(52) U.S. Cl. CPC B64C 1/1492; B64C 1/1484; B32B 17/10036; B32B 7/12; B32B 17/10743; B32B 2274/00; B32B 17/10761; B32B 2605/006; B32B 2605/18; B32B 2307/732; B32B 2307/102; B32B 17/1077

(57) ABSTRACT

An aircraft window composed of a monolithic interior pane made of polymer material and of a laminated exterior pane made of glass that are separated by an air-filled space, wherein the laminated exterior pane consists of two glass sheets bonded by an adhesive interlayer, and wherein the thickness of the exterior glass sheet is between 0.2 and 2.6 mm, and the thickness of the interior glass sheet is between 0.2 and 2.1 mm.

The present invention relates to a low-drag lightweight aircraft window, that is to say which, under the effect of the pressurization of the interior volume of the aircraft in flight, does not deform by forming with respect to the surrounding body of the plane, a bulge that is detrimental from an aerodynamic point of view and from the point of view of the energy consumption for propelling the aircraft.

Particularly targeted here are the windows of the type having two panes separated by an air-filled space. Such aircraft windows with two poly(methyl methacrylate) (PMMA) panes are known. In the event of rupture of the exterior pane, the interior pane makes it possible to keep the interior volume of the aircraft under a desired pressure. Even though the interior pane (or the peripheral seal with which it is in contact) is commonly provided with a small through-hole that makes it possible to keep the air-filled space under the pressure of the interior volume of the aircraft in flight under normal conditions, this interior pane is capable of keeping this interior volume of the aircraft under a desired pressure in flight in the event of rupture of the exterior pane, since this hole is sufficiently small; in this case, whistling may occur.

Document US 2015/047275 A1 describes an aircraft window composed of a monolithic interior pane made of polymer material and a laminated exterior pane made of glass which are separated by an air-filled space, but does not describe the structural features of the laminated exterior pane.

The inventors have become aware that the heavy and thick exterior pane made of monolithic polymer material could be replaced by a lighter laminate made of glass, of which it was possible to select the constituents so that, under the flight conditions, the exterior surface of the laminate matches the curvature of the surrounding fuselage of the aircraft.

For this purpose, one subject of the invention is an aircraft window composed of a monolithic interior pane made of polymer material and a laminated exterior pane made of glass which are separated by an air-filled space, characterized in that the laminated exterior pane consists of two sheets of glass bonded by means of an adhesive interlayer, in that the thickness of the exterior glass sheet is between 0.2 and 2.6 mm, and the thickness of the interior glass sheet is between 0.2 and 2.1 mm. The constituents of the laminated exterior pane made of glass, in particular the glass sheets, are selected and sized in order to obtain in particular a flexural stiffness of the exterior pane such that, under the effect of the pressurization of the interior volume of the aircraft in flight, the curvature of the exterior surface of this pane is substantially the same as that of its fitting environment (fuselage of the aircraft), guaranteeing the best aerodynamics of the assembly. The terms “interior” and “exterior” refer here to the interior and exterior of the aircraft.

It should be emphasized that the exterior surface of the window in contact with the air is made of glass, which is advantageous compared to a material such as poly(methyl methacrylate) (PMMA) or the like which, directly abraded by the air friction, loses good optical qualities of transparency, unlike glass, making it necessary, after a certain number of hours of flight, to repolish the PMMA. The invention therefore makes it possible to dispense with this maintenance operation.

The use, in accordance with the invention, of a laminated exterior pane made of glass, makes it possible to integrate an adhesive interlayer with an acoustic damping property, as will be seen in greater detail in the exemplary embodiments below.

The use of the laminated glass also enables the integration of functional layers within the laminated structure, such as solar control or low-emissivity layers protected both from exterior and interior atmosphere, layers for modifying light transmission (SPD (Suspended Particle Device) or electrochromic layers). Some of these layers, in particular metal layers, may be formed in motifs or patterns with holes with no layer, capable of enabling the passage of GSM, 3G, 4G, 5G waves and the like.

It is also advantageous to provide the face of the window in contact with the outside air with a layer for modifying the surface tension such as a hydrophobic, hydrophilic or even active layer such as a photocatalytic layer of the type having TiO₂ nanoparticles with a self-cleaning effect, without departing from the scope of the invention.

The structure of the window of the invention also facilitates the integration of antennas such as Wi-Fi antennas.

According to particular embodiments:
the monolithic interior pane is made of polymer material comprising a poly(methyl methacrylate) (PMMA), a polycarbonate (PC), alone or as mixtures or copolymers of several thereof.
the thickness of the exterior glass sheet is between 1.6 and 2.4 mm, and the thickness of the interior glass sheet is between 0.4 and 1.9 mm.
the laminated exterior pane comprises glass sheets made of chemically toughened glass, of soda-lime, aluminosilicate or borosilicate type.
the total thickness of glass of the laminated exterior pane is between 1.5 and 5 mm, preferably between 2 and 4.5 mm.
the laminated exterior pane comprises at least one adhesive interlayer chosen from a polyvinyl butyral (PVB), optionally having an acoustic damping property, a thermoplastic polyurethane (TPU), an ethylene/vinyl acetate copolymer (EVA), or an ionomer glass.
on the ground (stationary, at rest), the main surface of the laminated exterior pane opposite the monolithic interior pane is flat or convex with a lower curvature than that of the surrounding structure of the aircraft, so that in flight, under the effect of the pressurization of the interior volume of the aircraft, said main surface of the laminated exterior pane has a curvature substantially identical to that of the surrounding structure of the aircraft. When the laminated exterior pane is flat when the aircraft is stationary, the step of shaping/bending the constituent glass sheets of the laminate is advantageously dispensed with.
the air-filled space is at the pressure of the interior volume of the aircraft; this is obtained for example, as indicated above, by a small through-hole in the monolithic interior pane or the fitting seal thereof.

The appended drawing illustrates the invention:

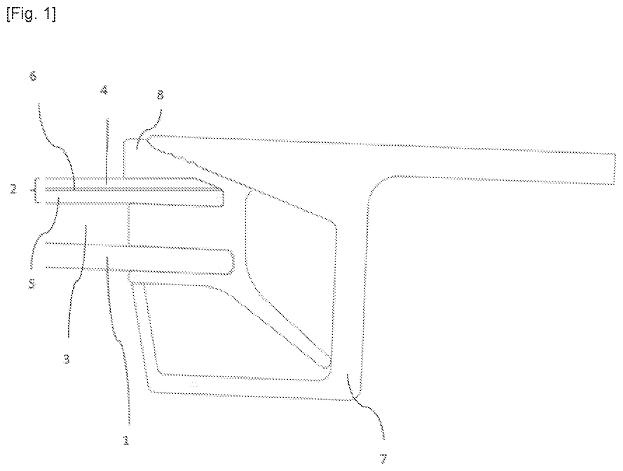

FIG. 1 is a partial schematic cross-sectional view of the aircraft window of the invention in the fitting position; the proportions of the dimensions of the constituents are not exact.

With reference to this drawing, the window comprises a monolithic interior pane 1 made of poly(methyl methacrylate) (PMMA) or polycarbonate (PC) having a thickness of between 2.5 and 12 mm, for example made of 4 mm thick PMMA, and a laminated outer pane 2 made of glass that are separated by an air-filled space 3.

Several compositions of laminated exterior pane 2 in accordance with the invention are given below, in the order: exterior glass sheet 4/adhesive interlayer 6/interior glass sheet 5:
2.1 mm/0.76 mm PVB/1.6 mm
2.1 mm/0.76 mm TPU/1.6 mm
2.1 mm/0.76 mm ionomer glass/1.6 mm
2.1 mm/acoustic PVB/1.6 mm
2.1 mm/acoustic PVB/0.7 mm.

The glass used is chemically toughened, of soda-lime, aluminosilicate or borosilicate type.
PVB: polyvinyl butyral
TPU: thermoplastic polyurethane
ionomer glass: sold by Kuraray under the registered trademark SentryGlas® XTRA® (SGX®)
acoustic PVB: acoustic tri-layer polyvinyl butyral, sold by Sekisui under the registered trademark S-LEC® Sound Acoustic Film, or else by Kuraray under the registered trademark Trosifol® Acoustic, in various thicknesses.

The monolithic interior pane 1 and the laminated exterior pane 2 are fitted to the structure of the aircraft (aluminum fitting 7) by means of a silicon seal 8.

These window structures, in particular those of the laminated exterior pane 2 made of glass cited above, make it possible to lighten the window while avoiding a deformation as an excessively large bulge in flight, which is unfavorable from an aerodynamic point of view.

1. An aircraft window composed of a monolithic interior pane made of polymer material and of a laminated exterior pane made of glass that are separated by an air-filled space, wherein the laminated exterior pane consists of two glass sheets bonded by an adhesive interlayer, and wherein the thickness of the exterior glass sheet is between 0.2 and 2.6 mm, and the thickness of the interior glass sheet is between 0.2 and 2.1 mm.

2. The aircraft window as claimed in claim 1, wherein the monolithic interior pane is made of polymer material comprising a poly(methyl methacrylate) (PMMA), a polycarbonate (PC), alone or as mixtures or copolymers of several thereof.

3. The aircraft window as claimed in claim 1, wherein the thickness of the exterior glass sheet is between 1.6 and 2.4 mm, and the thickness of the interior glass sheet is between 0.4 and 1.9 mm.

4. The aircraft window as claimed in claim 1, wherein the laminated exterior pane comprises glass sheets made of chemically toughened glass, of soda-lime, aluminosilicate or borosilicate type.

5. The aircraft window as claimed in claim 1, wherein the total thickness of glass of the laminated exterior pane is between 1.5 and 5 mm.

6. The aircraft window as claimed in claim 1, wherein the laminated exterior pane comprises at least one adhesive interlayer chosen from a polyvinyl butyral, optionally having an acoustic damping property, a thermoplastic polyurethane, an ethylene/vinyl acetate copolymer, or an ionomer glass.

7. The aircraft window as claimed in claim 1, wherein on the ground, a main surface of the laminated exterior pane opposite the monolithic interior pane is flat or convex with a lower curvature than that of a surrounding structure of the aircraft, so that in flight, under the effect of pressurization of an interior volume of the aircraft, said main surface of the laminated exterior pane has a curvature substantially identical to that of the surrounding structure of the aircraft.

8. The aircraft window as claimed in claim 1, wherein the air-filled space is at a pressure of an interior volume of the aircraft.

9. The aircraft window as claimed in claim 1, wherein the total thickness of glass of the laminated exterior pane is between 2 and 4.5 mm.
